(19) United States
(12) Patent Application Publication
(10) Pub. No.: US 2026/0063533 A1
(43) Pub. Date: Mar. 5, 2026

(54) OPTICAL MEASURING DEVICE

(71) Applicant: THE WAVE TALK, INC., Daejeon (KR)

(72) Inventor: Young Dug KIM, Seongnam-si (KR)

(73) Assignee: THE WAVE TALK, INC., Daejeon (KR)

(21) Appl. No.: 19/385,995

(22) Filed: Nov. 11, 2025

Related U.S. Application Data
(63) Continuation of application No. PCT/KR2025/002448, filed on Feb. 20, 2025.

(30) Foreign Application Priority Data
Jul. 19, 2024 (KR) 10-2024-0095434
Feb. 21, 2024 (KR) 10-2024-0024984

(51) Int. Cl. G01N 15/1434

(52) U.S. Cl. CPC G01N 15/1434

(57) ABSTRACT

The present disclosure relates to an optical measuring apparatus. An embodiment of the present disclosure provides an optical measuring apparatus including a chamber portion including a first chamber accommodating a sample, and a second chamber providing a space in which light interference with scattered light emitted from the first chamber occurs, a light source portion irradiating input light toward the chamber portion, a sensor portion detecting speckles of output light that is output from the chamber portion, and a controller configured to estimate information about target particles in the sample by using the speckles of the detected output light.

### CROSS-REFERENCE TO RELATED APPLICATIONS

This application is a continuation of International Application No. PCT/KR2025/002448 filed on February 20, 2025, which claims priority to Korean Patent Application No. 10-2024-0024984 filed on February 21, 2024 and Korean Patent Application No. 10-2024-0095434 filed on July 19, 2024, the entire contents of which are herein incorporated by reference.

### Technical Field

The present disclosure relates to an optical measuring apparatus.

### Background Art

Human beings coexist with various lives. Invisible lives, as well as visible lives, coexist with human beings, and directly/indirectly affect human lives. Among them, microorganisms or microscopic organisms affecting health states of the human beings are not visible to human eyes, but exist around the human beings and trigger various illnesses.

In order to measure invisible microorganisms, a microorganism cultivation method, a mass spectrometry method, a nuclear magnetic resonance method, etc. is used according to the related art. When the microorganism cultivation method, the mass spectrometry method, and the nuclear magnetic resonance method are used, it takes a long time period to cultivate bacteria and precise and complicated equipment of high expenses is necessary.

Alternately, a method of measuring microorganisms by using an optical method may be used. For example, a Raman spectrometry or a multispectral imaging method may be used as the optical method, but a complicated optical system is necessary, professional knowledge about the complicated optical system and equipment of laboratory level are also necessary, and measurement takes a long time period. Thus, it may be difficult for general public to access the system. In particular, in the case of an optical method performing measurement by using laser, a wavelength of laser changes due to external environmental elements, which makes accurate measurement difficult.

The above information disclosed in this background section is only for enhancement of understanding of the background of the disclosure and therefore it may contain information that does not form the related art that is already known to a person of ordinary skill in the art.

### Disclosure of Invention

### Technical Problem

One or more embodiments provide an optical measuring apparatus capable of precisely acquiring information on target particles included in a sample by using a light scattering effect or light interference effect.

It will be appreciated by one of ordinary skill in the art that the objectives and effects that could be achieved with the present disclosure are not limited to what has been particularly described above and other objectives and advantages of the present disclosure will be more clearly understood from the following detailed description and embodiments of the present disclosure.

Also, it will be readily understood that the objects and advantages of the present disclosure are realized by the means and combinations thereof set forth in the appended claims.

### Solution to Problem

To address the above technical problem, an optical measuring apparatus according to an embodiment of the present disclosure includes a chamber portion including a first chamber accommodating a sample, and a second chamber providing a space in which light interference with scattered light emitted from the first chamber occurs, a light source portion irradiating input light toward the chamber portion, a sensor portion detecting speckles of output light that is output from the chamber portion, and a controller configured to estimate information about target particles in the sample by using the speckles of the detected output light.

To address the above technical problem, an optical measuring apparatus according to an embodiment of the present disclosure includes a light source portion generating input light, a chamber portion providing a space in which the input light input from the light source portion is multi-reflected or multi-scattered through multiple passages, a sensor portion detecting speckles of scattered light output from the chamber portion, a first polarization unit that is arranged between the chamber portion and the light source portion and arranged on an optical path of the input light, and a second polarization unit that is arranged between the chamber portion and the sensor portion, arranged on an optical path of the scattered light, and has a polarization axis crossing a polarization axis of the first polarization unit.

### Advantageous Effects of Invention

According to embodiments, an optical measuring apparatus includes a chamber portion providing a space in which interference of light scattered by target particles occurs, and thus, a sensor portion may acquire optical data of high intensity.

Effects obtainable from the present disclosure may be non-limited by the above-mentioned effect. Other unmentioned effects may be clearly understood from the following description by one of ordinary skill in the art to which the present disclosure pertains.

### Brief Description of Drawings

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a diagram schematically showing an optical measuring apparatus according to an embodiment of the present disclosure.

FIG. 2 is a diagram schematically showing an optical measuring apparatus in which a light source portion includes a first light source and a second light source, according to an embodiment of the present disclosure.

FIG. 3 is a diagram schematically showing an optical measuring apparatus including a light distributor, according to an embodiment of the present disclosure.

FIG. 4 is a diagram schematically showing an optical measuring apparatus including an angle adjuster, according to an embodiment of the present disclosure.

FIG. 5 is a diagram schematically showing an optical measuring apparatus including a polarizer, according to an embodiment of the present disclosure.

FIG. 6 is a diagram schematically showing an optical measuring apparatus including a magnetic field generator, according to an embodiment of the present disclosure.

FIG. 7 is a diagram for illustrating a status of using a controller, according to an embodiment of the present disclosure.

FIG. 8 is a diagram schematically showing an optical measuring apparatus according to another embodiment of the present disclosure.

### Best Mode for Carrying out the Invention

To address the above technical problem, an optical measuring apparatus according to an embodiment of the present disclosure includes a chamber portion including a first chamber accommodating a sample, and a second chamber providing a space in which light interference with scattered light emitted from the first chamber occurs, a light source portion irradiating input light toward the chamber portion, a sensor portion detecting speckles of output light that is output from the chamber portion, and a controller configured to estimate information about target particles in the sample by using the speckles of the detected output light.

In the embodiment, the chamber portion may further include a barrier wall portion partitioning inside of the first chamber and inside of the second chamber from each other, and transmitting the scattered light.

In the embodiment, the input light irradiated from the light source portion may include first input light irradiated into the first chamber and second input light irradiated into the second chamber, the first input light and the target particles colliding with each other in the first chamber to generate the scattered light, and the sensor portion may detect the speckles of the output light that is generated through light interference between the scattered light and the second input light in the second chamber.

In the embodiment, the optical measuring apparatus may further include a light distributor that is arranged between the chamber portion and the light source portion and branches the input light irradiated from the light source portion into the first input light and the second input light, wherein the first input light and the second input light branched by the light distributor may have wavelengths within a same range.

In the embodiment, the optical measuring apparatus may further include an angle adjuster that is arranged between the chamber portion and the light source portion, and is capable of adjusting an incident angle of the first input light or an incident angle of the second input light with respect to the chamber portion.

In the embodiment, the sensor portion may include a first sensor that is arranged adjacent to the first chamber and detects the scattered light, and a second sensor that is arranged closer to the second chamber than the first sensor and measures the output light, and a light intensity of the output light acquired by the second sensor may be relatively greater than a light intensity of the scattered light acquired by the first sensor.

In the embodiment, the optical measuring apparatus may further include a polarizer that is arranged on an optical path of the second input light and has a polarization axis set in advance.

To address the above technical problem, an optical measuring apparatus according to an embodiment of the present disclosure includes a light source portion generating input light, a chamber portion providing a space in which the input light input from the light source portion is multi-reflected or multi-scattered through multiple passages, a sensor portion detecting speckles of scattered light output from the chamber portion, a first polarization unit that is arranged between the chamber portion and the light source portion and arranged on an optical path of the input light, and a second polarization unit that is arranged between the chamber portion and the sensor portion, arranged on an optical path of the scattered light, and has a polarization axis crossing a polarization axis of the first polarization unit.

In the embodiment, the polarization axis of the first polarization unit and the polarization axis of the second polarization unit may be perpendicular to each other.

In the embodiment, the optical measuring apparatus may further include a driver capable of adjusting the polarization axis of the second polarization unit.

### Mode for the Invention

Hereinafter, one or more embodiments of the present disclosure will be described in detail with reference to accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the spirit and scope of the disclosure.

In addition, it will be further understood that the terms that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

In addition, the accompanying drawings are not shown according to the actual scale to help understand the disclosure, but the dimensions of some components may be exaggerated. Furthermore, the same element in different embodiments may be given the same reference numeral.

The term equal refers to 'substantially equal'. Accordingly, substantially equal may include the deviation regarded as a low level in the corresponding technical field, for example, the deviation of 5% or less. In addition, a uniform parameter in a predetermined area may refer to uniform from the average point of view.

Expressions including ordinal numbers such as "first" and "second" indicate various elements, but the above expressions do not limit the elements. These terms are used to distinguish one element from another, and unless the context clearly indicates otherwise, a first element may be a second element.

As used herein, the singular forms are intended to include the plural forms as well, unless the context clearly indicates otherwise.

It will be understood that when an element is referred to being "on (or below)" or "above (or under)" another element, it may be positioned in contact with an upper surface (or a lower surface) of the other element, but another element may be positioned between the element and the other element on (or below) the element.

It will be further understood that when an element is referred to as being "connected", "coupled" or "joined" to another element, the elements may be directly connected or joined to each other, but intervening elements may be present between them or each element may be "connected", "coupled" or "joined" to each other through another element. It will be understood that when an element is referred to as being "electrically coupled" to another element, the element can be directly electrically coupled to another element or intervening elements may be present.

Throughout the specification, the terms "A and/or B" imply A, B, or A and B, unless otherwise defined. That is, the term "and/or" includes all or various combinations of a plurality of items that are related and arranged. The terms “C to D” imply C or more and D or less, unless otherwise described.

The terminology used herein is for the purpose of describing embodiments of the present disclosure and is not intended to be limiting of the present disclosure.

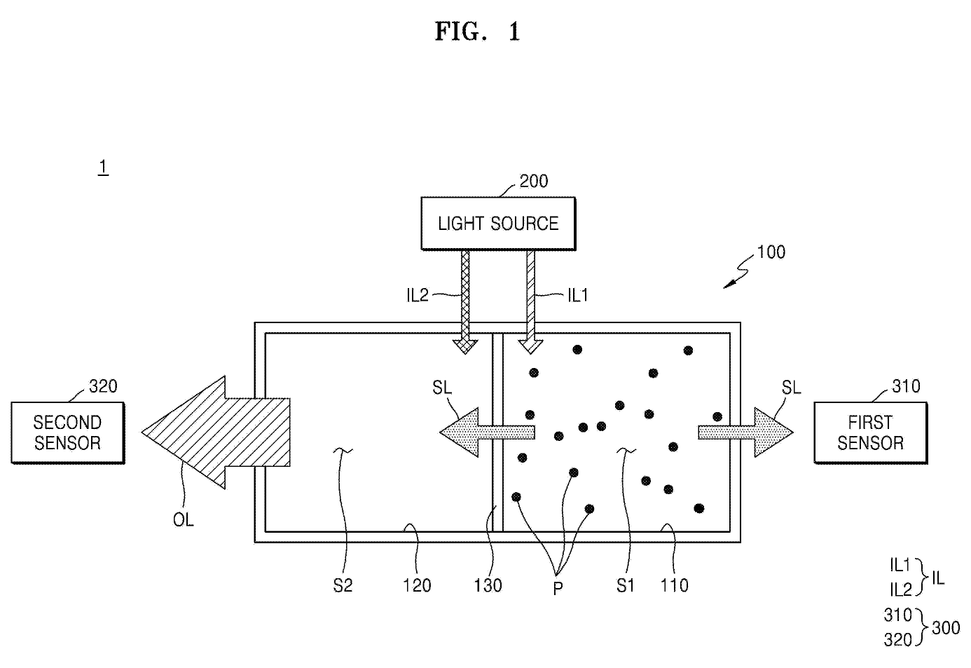

FIG. 1 is a diagram schematically showing an optical measuring apparatus according to an embodiment of the present disclosure.

Referring to FIG. 1, an optical measuring apparatus 1 according to an embodiment of the present disclosure estimates information on target particles in a sample by using light speckles, and may include a chamber portion 100, a light source portion 200, and a sensor portion 300.

The optical measuring apparatus 1 is a device for detecting information on target particles, e.g., whether the target particles exist in a sample, etc., by using light, for example, the optical measuring apparatus 1 may detect information on a size, shape, structure, etc. of the target particles, by detecting speckles of light scattered due to interaction with the target particle in a time-serial manner.

In the present specification, the sample may include target particles to be detected, and may include a solution of a certain concentration using a solvent. The sample or the target particle in the sample may include a chemical material or a biologically derived material such as microorganisms.

Referring to FIG. 1, the chamber portion 100 according to an embodiment of the present disclosure accommodates the sample, and may include a first chamber 110, a second chamber 120, and a barrier wall portion 130.

The chamber portion 100 may be formed in a polyhedron having hollow inside, a spherical shape, an elliptical shape, a crushed spherical shape, a crushed elliptical shape, a cylindrical shape, or an inclined cylindrical shape, but is not limited thereto.

The first chamber 110 provides a space in which the sample is accommodated, and the second chamber 120 may provide a space in which scattered light SL emitted from the first chamber 110 is optically interfered.

In the present specification, the first chamber 110 and the second chamber 120 may be interpreted as different spaces partitioned by the barrier wall portion 130 in the chamber portion 100, but are not limited thereto. In addition, the first chamber 110 and the second chamber 120 may be interpreted as chambers separately formed from each other.

At one side of the first chamber 110, an entrance (not illustrated in the drawings) into which input light IL irradiated from the light source portion 200, e.g., first input light IL1, is input may be formed. The light source portion 200 may irradiate the first input light IL1 into the first chamber 110 via the entrance located at one side of the first chamber 110, and the first input light IL1 may be multi-reflected and multi-scattered by colliding with an inner circumferential surface of the first chamber 110 and the target particles in the first chamber 110.

In the present specification, a region formed by the first chamber 110 is referred to as a 'first region', and a region formed by the second chamber 120 is referred to as a 'second region'.

In the present specification, the input light IL denotes the light irradiated from the light source portion 200 toward the chamber portion 100, the first input light IL1 denotes the light irradiated from the light source portion 200 toward the first chamber 110, and second input light IL2 denotes light irradiated from the light source portion 200 toward the second chamber 120.

In an embodiment, a scattering layer may be applied onto the inner circumferential surface of the first chamber 110. The scattering layer may include a scattering material, for example, the scattering layer may include a hexagonal-boron nitride (h-BN).

In an alternative embodiment, the inner circumferential surface of the first chamber 110 may have a preset roughness, for example, the inner circumferential surface of the first chamber 110 may have a regular or irregular concavo-convex structure, thereby implementing a multiple-scattering amplification function.

In an alternative embodiment, a multiple scatterer (not shown) that increases an optical path length of the first input light IL1 may be arranged in the first chamber 110. The multiple scatterer may be arranged on an optical path of the first input light IL1, and the multiple scatterer may amplify the number of times that the light irradiated from the light source portion 200 to the first chamber 110 is multi-scattered, so that the optical path length of the first input light IL1 may increase in the first chamber 110.

As such, the first input light IL1 irradiated from the light source portion 200 into the first chamber 110 may be effectively absorbed/reflected/scattered by the target particles in the first region, and accordingly, even when a fine amount of target particles exist in the sample, sufficient scattered light SL or speckles of the scattered light SL may be output.

An outlet (not shown) may be formed at one side of the first chamber 110, which faces the sensor portion 300, and the scattered light SL output from the first chamber 110 may be discharged to the outside of the chamber portion 100 through the outlet.

In the present specification, the scattered light SL may be interpreted as light or speckles of light that is, in the first input light IL1 irradiated on the first chamber 110, scattered by the target particles or the inner circumferential surface of the first chamber 110 and a controller 800 may estimate/detect information on the existence, kind, shape, and size of the target particles by using the speckles of the scattered light SL. The controller 800 may include a processor and a memory storing instructions that, when executed by the processor, instruct the controller 800 to perform the functions described herewith.

The sensor portion 300, in particular, a first sensor 310, may detect the scattered light SL output from the outlet of the first chamber 110. However, the disclosure is not limited thereto, and the first sensor 310 may detect the first input light IL1 or speckles of the first input light IL1 that is not scattered in the first chamber 110.

As such, the controller 800 may receive speckle information of the scattered light SL and the first input light IL1 from the first sensor 310, and may detect the information on the target particles included in the sample. The scattered light SL scattered in the first chamber 110 may be output to the second chamber 120 via the barrier wall portion 130.

The barrier wall portion 130 may include an opening allowing the first chamber 110 and the second chamber 120 to be in communication with each other. The scattered light SL in the first chamber 110 may be output to the second chamber 120 via the opening, and the scattered light SL output to the second chamber 120 and the second input light IL2 irradiated onto the second chamber 120 optically interfere with each other in the second region and output light OL obtained by amplifying the light intensity of the scattered light SL may be generated.

In the present specification, the output light OL may be interpreted as light or speckles of the light generated through the optical interference between the second input light IL2 and the scattered light SL, and the controller 800 may estimate/detect the information on the existence, kind, shape, and size of the target particles by using the speckles of the output light OL.

Referring to FIG. 1, the second chamber 120 according to an embodiment of the present disclosure provides a space where the light interference of the scattered light SL emitted from the first chamber 110 occurs, and may be arranged adjacent to the first chamber 110.

At one side of the second chamber 120, an entrance (not shown) into which the input light IL irradiated from the light source portion 200, in particular, second input light IL2, is input may be formed. The light source portion 200 may irradiate the second input light IL2 into the second chamber 120 through the entrance located at one side of the second chamber 120, the second input light IL2 collides with an inner circumferential surface of the second chamber 120 in the second region and then multi-reflected and multi-scattered, and the second input light IL2 that is multi-reflected and multi-scattered may optically interfere with the scattered light SL emitted from the first chamber 110 via the barrier wall portion 130.

In an embodiment, the inner circumferential surface of the second chamber 120 may be formed as various shapes including various materials so that the interference between the scattered light SL and the second input light IL2 may be maximized or precisely controlled.

For example, the inner circumferential surface of the second chamber 120 may be formed as a CSMS (web) structure, chiral sculptured thin film (CSTF) structure, photonic crystal structure, a honeycomb structure, isotropic and anisotropic structures, metamaterial structure, polarization maintaining fiber, etc.

In an alternative embodiment, a scattering layer may be applied onto the inner circumferential surface of the second chamber 120. The scattering layer may include a scattering material, for example, the scattering layer may include a hexagonal-boron nitride (h-BN).

In an alternative embodiment, the inner circumferential surface of the second chamber 120 may have a preset roughness, for example, the inner circumferential surface of the second chamber 120 may have a regular or irregular concavo-convex structure, thereby implementing a multiple scatterering amplification function.

In an alternative embodiment, the multiple scatterer increasing the optical path length of the second input light IL2 may be arranged in the second chamber 120. The multiple scatterer may be arranged on an optical path of the second input light IL2, and the multiple scatterer may amplify the number of times that the light irradiated from the light source portion 200 to the second chamber 120 is multi-scattered so that the optical path length of the scattered light SL or the second input light IL2 may increase in the second chamber 120.

As such, the scattered light SL discharged from the first chamber 110 optically interferes with the second input light IL2 in the second chamber 120 and generates the output light OL, and the output light OL having increased light intensity, sensitivity, etc. as compared with the scattered light SL is discharged toward the side of the second sensor 320 via one side of the second chamber 120. Thus, the second sensor 320 acquires the scattered light SL having increased sensitivity, in particular, the output light OL, and the controller 800 may effectively detect the optical information/speckles including the information on the target particle.

An outlet (not shown) may be formed at one side of the second chamber 120, which faces the sensor portion 300, in particular, a second sensor 320, and the output light OL output from the second chamber 120 may be discharged to the outside of the chamber portion 100 via the outlet. As such, the second sensor 320 acquires the output light OL or speckles of the output light OL output from the second chamber 120, and thus, the controller 800 may estimate the information about the target particles.

Referring to FIG. 1, the barrier wall portion 130 according to an embodiment of the present disclosure partitions the inside of the first chamber 110 from the inside of the second chamber 120, and may be arranged between the first chamber 110 and the second chamber 120.

In an embodiment, the barrier wall portion 130 may include a material having low light transmittance, and may have an opening (not shown) formed in one side thereof. As such, the scattered light SL generated from the first chamber 110 may enter the second chamber 120 via the opening.

In an alternative embodiment, the barrier wall portion 130 may include a material through which the light may pass, the scattered light SL generated from the first chamber 110 may enter the second chamber 120 after passing through the barrier wall portion 130, and accordingly, the scattered light SL entering the second chamber 120 after passing through the barrier wall portion 130 may generate light interference with the second input light IL2 irradiated into the second chamber 120 and the output light OL may be generated in the second chamber 120.

The barrier wall portion 130 may be formed as a wall or plate partitioning the first chamber 110 and the second chamber 120 from each other, but is not limited thereto. That is, the barrier wall portion 130 may include a flow path or a pipe allowing the first region and the second region to be in communication with each other.

Referring to FIG. 1, the light source portion 200 according to an embodiment of the present disclosure irradiates the input light IL toward the chamber portion 100, and may be a laser source of the optical measuring apparatus 1.

The light source portion 200 may irradiate the input light IL of a single color or multiple colors. For example, the light source portion 200 may include a source device generating light of a single color such as a gas laser, a semiconductor laser, or a laser diode, or the light source portion 200 may include a device capable of generating the input light IL of multiple colors such as a halogen lamp, a Xenon lamp, or a white light-emitting diode.

In an embodiment, the light source portion 200 may generate input light IL of different wavelengths. For example, the light source portion 200 may include a plurality of optical filters that transmit different wavelengths.

The light source portion 200 may irradiate the first input light IL1 into the first chamber 110, and in detail, the light source portion 200 may irradiate the first input light IL1 into the first region via the opening formed at one side of the first chamber 110.

Also, the light source portion 200 may irradiate the second input light IL2 into the second chamber 120, and in detail, the light source portion 200 may irradiate the second input light IL2 into the second region via the opening formed at one side of the second chamber 120.

Referring to FIG. 1, the sensor portion 300 according to an embodiment of the present disclosure may detect the speckles of the output light OL output from the chamber portion 100, and may include the first sensor 310 and the second sensor 320.

In an embodiment, the first sensor 310 is arranged on an optical path in which the speckles of the scattered light SL are output, and may detect the speckles of the scattered light SL in a time-serial manner.

When the light source portion 200 irradiates the input light IL of the visible ray band, the first sensor 310 may be a charge coupled device (CCD) camera, and the first sensor 310 may acquire a plurality of images by photographing the speckles of the scattered light SL in a time-serial manner.

The first sensor 310 detects a first image about the speckles of the scattered light SL on at least a first point in time, and captures a second image about the speckles of the scattered light SL at a second point in time and may provide the image to the controller 800. In addition, the first point in time and the second point in time are examples selected for convenience of description, and the first sensor 310 may capture a plurality of images at a plurality of points in time, which are more than the first and second points in time.

However, the disclosure is not limited thereto, and the first sensor 310 may include various types of image sensors capable of detecting the scattered light SL and speckle images of the scattered light SL.

The first sensor 310 may be arranged adjacent to the first chamber 110. For example, the first sensor 310 may be arranged on a region opposite to the second chamber 120 based on the first chamber 110, and may detect the speckles of the scattered light SL discharged from the opening of the first chamber 110.

In an embodiment, the second sensor 320 may be arranged on the optical path through which the speckles of the output light OL are output, and may detect the speckles of the output light OL in a time-serial manner.

When the light source portion 200 irradiates the input light IL of the visible ray band, the second sensor 320 may be a CCD camera, and the second sensor 320 may acquire a plurality of images by photographing the speckles of the output light OL in a time-serial manner.

The second sensor 320 detects a first image about the speckles of the output light OL on at least a first point in time, and captures a second image about the speckles of the output light OL at a second point in time and may provide the image to the controller 800. In addition, the first point in time and the second point in time are examples selected for convenience of description, and the second sensor 320 may capture a plurality of images at a plurality of points in time, which are more than the first and second points in time.

However, the disclosure is not limited thereto, and the second sensor 320 may include various kinds of image sensors capable of detecting the output light OL or the speckle image of the output light OL.

The second sensor 320 may be arranged closer to the second chamber 120 than the first sensor 310. For example, the second sensor 320 may be arranged on a region opposite to the first chamber 110 based on the second chamber 120, and may detect the speckles of the output light OL discharged from the opening of the second chamber 120.

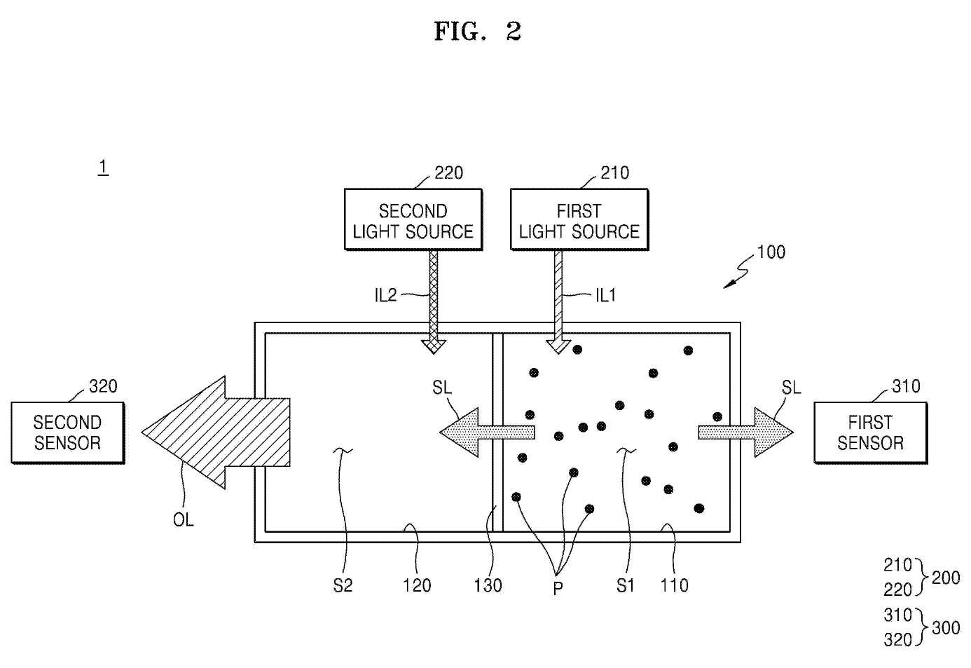

FIG. 2 is a diagram schematically showing an optical measuring apparatus in which a light source portion includes a first light source and a second light source, according to an embodiment of the present disclosure.

Referring to FIG. 2, the light source portion 200 of the optical measuring apparatus 1 according to an embodiment of the present disclosure may include a first light source 210 and a second light source 220.

The first light source 210 and the second light source 220 may be optical devices that are separately formed, and the first light source 210 may irradiate the first input light IL1 to the first chamber 110 and the second light source 220 may irradiate the second input light IL2 to the second chamber 120.

The first light source 210 may be arranged closer to the first chamber 110 than the second light source 220. For example, the first light source 210 may be arranged to face an outer circumferential surface of the first chamber 110 and may irradiate the first input light IL1 into the first region through the entrance formed at one side of the first chamber 110.

The second light source 220 may be arranged closer to the second chamber 120 than the first light source 210 and may irradiate the second input light IL2 into the second region through the entrance formed at one side of the second chamber 120.

At least one of the first light source 210 and the second light source 220 may irradiate input light IL of a single color or multi-colors. For example, at least one of the first light source 210 and the second light source 220 may include a source device generating light of a single color such as a gas laser, a semiconductor laser, or a laser diode, or may include a device capable of generating the input light IL of multi-colors such as a halogen lamp, a Xenon lamp, or a white light-emitting diode.

In an embodiment, the first light source 210 and the second light source 220 may generate the input light IL of different wavelengths. For example, the first light source 210 and the second light source 220 may respectively include optical filters transmitting different wavelengths.

Positions and postures of the first light source 210 and the second light source 220 may be independently adjusted, and as such, the positions and postures of the first light source 210 and the second light source 220 are adjusted according to kinds of target particles, kinds of the input light IL, and the size of the chamber portion 100, etc. so that the intensity and incident angle of the first input light IL1 irradiated on the first region and the intensity and incident angle of the second input light IL2 irradiated on the second region may be respectively adjusted.

The positions and postures of the first light source 210 and the second light source 220 may be interpreted as separation distances between the first and second light sources 210 and 220 and the chamber portion 100 or angles made by the first and second light sources 210 and 220 and the chamber portion 100.

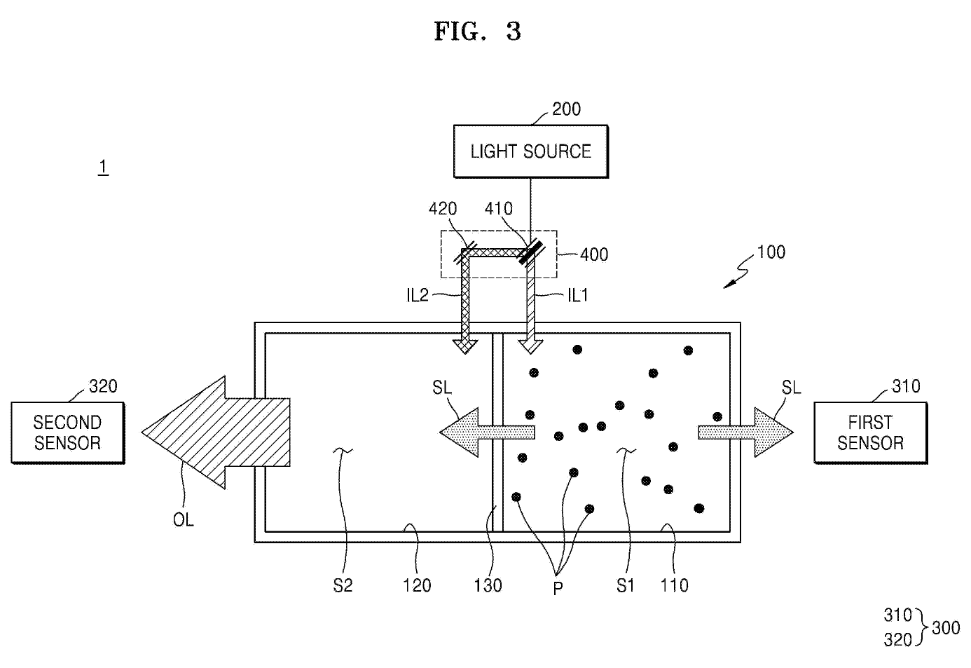

FIG. 3 is a diagram schematically showing the optical measuring apparatus 1 including a light distributor, according to an embodiment of the present disclosure.

Referring to FIG. 3, the optical measuring apparatus 1 according to an embodiment of the present disclosure may include a light distributor 400.

The light distributor 400 according to an embodiment of the present disclosure may branch the first input light IL1 and the second input light IL2 irradiated from the light source portion 200, and may include a splitter 410 and a mirror portion 420.

Referring to FIG. 3, the light distributor 400 may be arranged between the light source portion 200 and the chamber portion 100 and may be arranged on the optical path of the input light IL.

The light distributor 400 may include various devices capable of receiving the input light IL from the light source portion 200 and branching the input light into the first input light IL1 and the second input light IL2, for example, the light distributor 400 may include a beam splitter, a prism coupler, a wavelength division multiplexer (WDM), a fiber coupler, a dichroic mirror, etc.

The light distributor 400 may receive driving power from outside so as to adjust the position and angle thereof, and as such, the intensity of each of the first input light IL1 and the second input light IL2, an irradiation direction of the first input light IL1, and an irradiation direction of the second input light IL2 may be adjusted.

Here, because the light distributor 400 provides the same optical conditions except dividing of the input light IL into the first input light IL1 and the second input light IL2 or changing of the optical path, the properties of the first input light IL1 and the second input light IL2 are the same.

Therefore, the first input light IL1 may be used as incident light for generating speckles of the scattered light SL containing information of the target particles, and the second input light IL2 may be used as interference inducing light for amplifying the scattered light SL.

For example, the wavelengths of the first input light IL1 and the second input light IL2 branched by the light distributor 400 are in the same range, and as such, the scattered light SL generated when the first input light IL1 is scattered by the target particles in the first region may be also in the same wavelength range as the second input light IL2. Accordingly, the optical interference between the second input light IL2 and the scattered light SL in the same wavelength range in the second region may actively occur.

The splitter 410 is arranged on the optical path of the input light IL and may branch the input light IL into the first input light IL1 and the second input light IL2.

The splitter 410 may include various devices capable of dividing one beam into two beams, for example, the splitter 410 may include a plate beam splitter, a cube beam splitter, a polarizing beam splitter (PBS), a dichroic beam splitter, a non-polarizing beam splitter (NPBS), a variable beam splitter, a hybrid beam splitter, etc.

The splitter 410 may receive application of driving power from outside to adjust the position or angle thereof, and as such, the direction in which the first input light IL1 or the second input light IL2 reflected by the splitter 410 or transmitted through the splitter 410 is irradiated onto the chamber portion 100 may be adjusted.

The mirror may include a device changing the optical path of the first input light IL1 or the second input light IL2, for example, the mirror portion 420 may include a micro electromechanical system (MEMS) mirror, a digital micro-mirror device (DMD), a beam reflector, etc.

The mirror portion 420 may receive transfer of the driving power from the outside so as to adjust the angle formed with the chamber portion 100, and as such, the light irradiation path of the first input light IL1 or the second input light IL2 of which the optical path is adjusted by the mirror portion 420 may be adjusted.

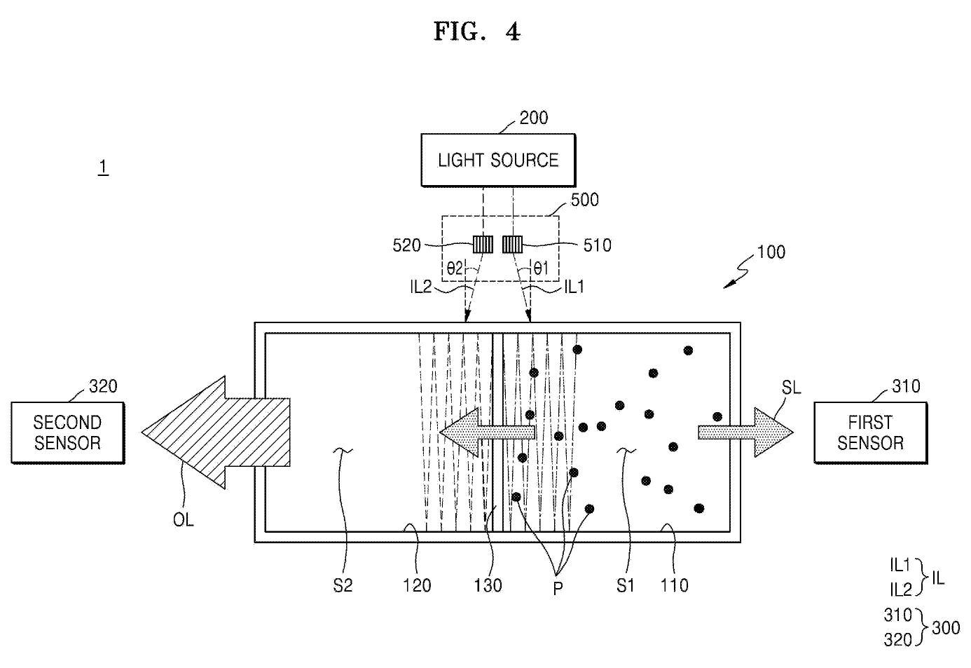

FIG. 4 is a diagram schematically showing the optical measuring apparatus 1 including an angle adjuster, according to an embodiment of the present disclosure.

Referring to FIG. 4, the optical measuring apparatus 1 according to an embodiment of the present disclosure may include an angle adjuster 500 which adjusts a light irradiation path of at least one of the first input light IL1 and the second input light IL2.

The angle adjuster 500 according to an embodiment of the present disclosure may be arranged between the light source portion 200 and the chamber portion 100, so that incident angles θ1 and θ2 of the input light IL with respect to the chamber portion 100 is adjustable, and may include a first angle adjustment unit 510 and a second angle adjustment unit 520.

The first angle adjustment unit 510 may receive the first input light IL1 from the light source portion 200 and adjust the incident angle θ1 of the first input light IL1 irradiated to the first region, and the second angle adjustment unit 520 may receive the second input light IL2 from the light source portion 200 and adjust the incident angle θ2 of the second input light IL2 irradiated to the second region.

As such, when the first angle adjustment unit 510 adjusts the incident angle θ1 of the first input light IL1 irradiated to the first region, the number of multiple reflections and the number of multiple scattererings of the first input light IL1 due to the target particles in the first region may be adjusted. Thus, a user may appropriately control the driving of the first angle adjustment unit 510 according to the kinds of samples accommodated in the first region, kinds of input light IL, etc.

When the second angle adjustment unit 520 adjusts the incident angle θ2 of the second input light IL2 irradiated onto the second region, the number of multiple reflections and the number of multiple scattererings of the second input light IL2 in the second region, and a degree of constructive interference between the scattered light SL and the second input light IL2 may be adjusted. As such, the user may appropriately control the driving of the first angle adjustment unit 510 according to the kinds of the samples accommodated in the first region, the kinds of input light IL, a size of the incident angle θ1 of the first input light IL1, etc., and may appropriately detect the speckles of the output light OL.

In an embodiment, the angle adjuster 500, in particular, the first angle adjustment unit 510 and the second angle adjustment unit 520, may include various devices capable of adjusting an optical path, for example, the angle adjuster 500 may include a galvanometer mirror, a piezoelectric tilt mirror, a micro-electro-mechanical systems (MEMS) mirror, a motorized stage, a rotary stage, a goniometer, a tilting optic, an electro-optic deflector, an acousto-optic deflector, a parallel kinematic machine (PKM), etc.

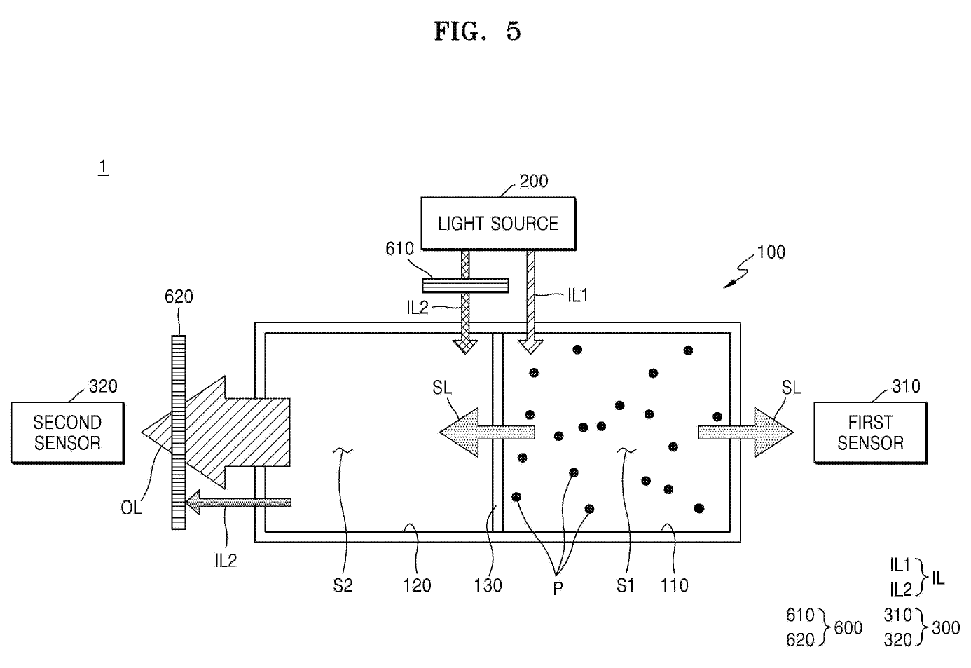

FIG. 5 is a diagram schematically showing the optical measuring apparatus 1 including a polarizer, according to an embodiment of the present disclosure.

Referring to FIG. 5, the optical measuring apparatus 1 according to an embodiment of the present disclosure may include a polarizer 600 which is arranged on an optical path of the second input light IL2 and has a polarization axis set in advance.

The polarizer 600 according to an embodiment of the present disclosure may include a first polarization unit 610 arranged between the light source portion 200 and the chamber portion 100, and a second polarization unit 620 arranged between the chamber portion 100 and the sensor portion 300.

The first polarization unit 610 is arranged on the optical path of the second input light IL2 irradiated to the second chamber 120 from the light source portion 200, and the second input light IL2 may be polarized according to the polarization axis of the first polarization unit 610 and then irradiated to the second chamber 120.

In an embodiment, the polarization axis of the first polarization unit 610 and the polarization axis of the second polarization unit 620 may be perpendicular to each other.

Some of the second input light IL2 irradiated to the second region may not interfere with the scattered light SL and may be multi-reflected and multi-scattered while maintaining original properties thereof, and the second input light IL2 with the its original properties may be discharged to the outside of the second chamber 120 and acquired by the second sensor 320.

In the embodiments of the present disclosure, the second sensor 320 acquires the output light OL generated through the interference between the second input light IL2 and the scattered light SL in order to detect information on the target particles, and thus, it is required to prevent the second input light IL2 maintaining the its original properties without any interference from being discharged to the second sensor 320.

Unlike this, when the second input light IL2 polarized by the first polarization unit 610 and irradiated to the second region interferes with the scattered light SL and generates the output light OL, the second input light IL converted into the output light OL loses its original properties polarized by the first polarization unit 610.

The second polarization unit 620 is arranged between the second chamber 120 and the second sensor 320 and is arranged on the optical path of the output light OL, and the polarization axis of the second polarization unit 620 may be perpendicular or nearly perpendicular to the polarization axis of the first polarization unit 610.

In this case, the second input light IL2 that is polarized by the first polarization unit 610 while maintaining the original properties and the output light OL that loses the polarization property are discharged toward the second sensor 320 through the outlet of the second chamber 120, but the second input light IL2 that is discharged without interfering with the scattered light SL is still in the polarized state due to the first polarization unit 610. Thus, the second input light IL2 may not pass through the second polarization unit 620 having the polarization axis perpendicular to the first polarization unit 610 and may not reach the second sensor 320. Unlike this, the output light OL that interferes with the scattered light SL and is not in polarized state in one direction may pass through the second polarization unit 620 and reach the second sensor 320.

As such, the second polarization unit 620 may reduce/prevent the effect that the light without interference reaches the second sensor 320, and at the same time, selectively transmits only the output light OL that is required to detect information on the target particle toward the second sensor 320. Thus, the noise may be reduced from the data acquired by the controller 800 and the information of the target particle may be precisely detected and estimated.

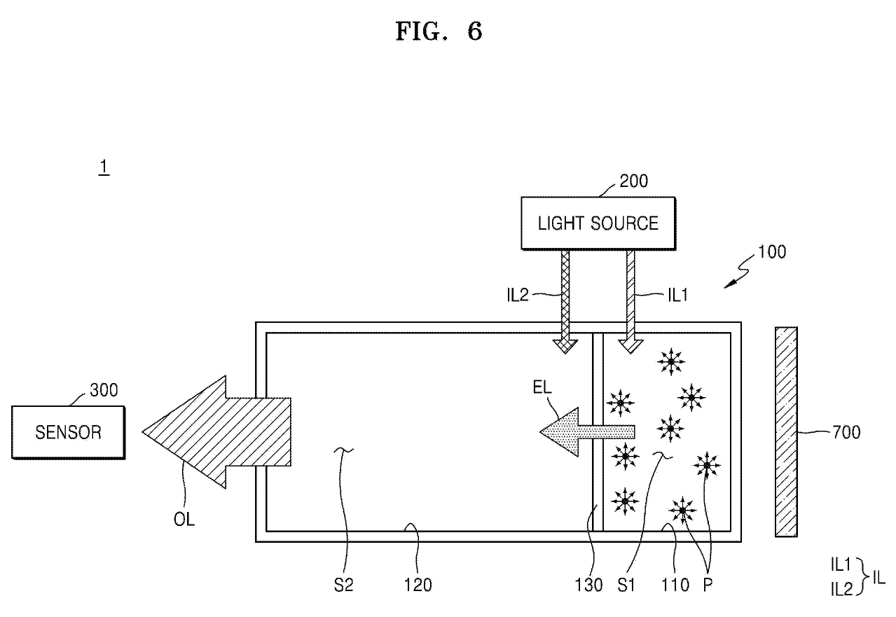

FIG. 6 is a diagram schematically showing the optical measuring apparatus 1 including a magnetic field generator, according to an embodiment of the present disclosure.

The optical measuring apparatus 1 according to an embodiment of the present disclosure may include a magnetic field generator 700.

In an embodiment, the target particles may include a fluorescent material such as microorganisms, etc. that absorbs light of a certain wavelength and discharges light of another wavelength.

The light source portion 200 may irradiate the first input light IL1 of a preset wavelength to the first chamber 110, and in this case, the first input light IL1 may be a visible ray, an ultraviolet ray, an infrared ray, an electronic ray, etc. corresponding to the fluorescent characteristics of the target particles, and the target particles may absorb the first input light IL1 and discharge excited light EL.

The sensor portion 300 may include a sensing unit corresponding to the fluorescent characteristics of the first input light IL1 or the target particles, for example, when the light source portion 200 uses laser of a visible ray band, the sensor portion 300 may include an imaging device capturing images, e.g., a CCD camera, and when the light source portion uses laser of a wavelength band corresponding to the fluorescent material, the sensor portion 300 may include a fluorescent detector.

Referring to FIG. 6, the magnetic field generator 700 according to an embodiment of the present disclosure may be arranged facing one surface of the first chamber 110, and may apply magnetic force to the target particles accommodated in the first chamber 110.

The magnetic field generator 700 may include a sample including the target particles or various devices capable of applying the magnetic force into the first region, for example, the magnetic field generator 700 may include a permanent magnet, an electromagnet, a superconducting electromagnet, a Helmholtz coil, a solenoid, a magnetic stirrer, a magnetic trap, neodymium, etc.

Accordingly, the magnetic field generator 700 changes the magnetic field applied to the first region, and thus, the excited light EL discharged from the target particle may be maximized.

The target particles accommodated in the first chamber 110 may receive the application of the first light source 210 and discharge the excited light EL, and the excited light EL may be discharged to the second chamber 120 via the barrier wall portion 130.

The light source portion 200 may irradiate the second input light IL2 to the second chamber 120, and the excited light EL discharged from the first chamber 110 and the second input light IL2 may optically interfere with each other in the second region. The speckles of the output light OL that is changed in a time-serial manner may be generated due to the optical interference between the excited light EL and the second input light IL2, and the sensor portion 300 may detect information on the target particles by detecting the speckles of the output light OL.

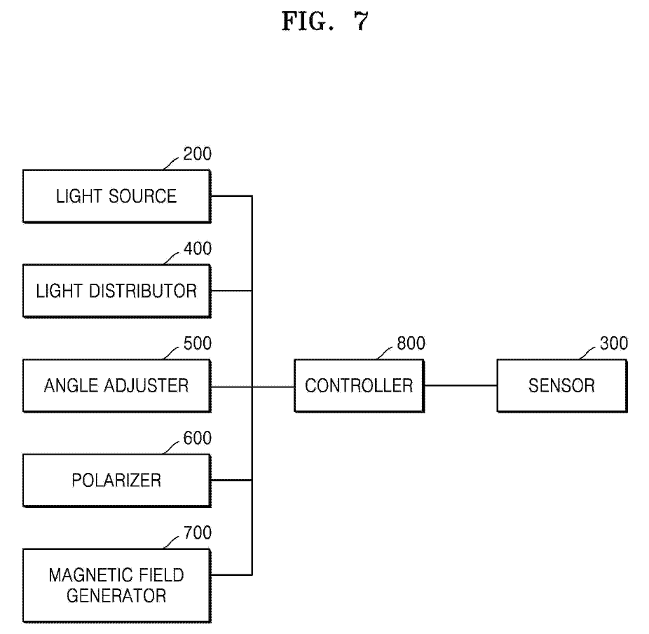

FIG. 7 is a diagram for illustrating a status of using a controller, according to an embodiment of the present disclosure.

Referring to FIG. 7, the optical measuring apparatus 1 according to an embodiment of the present disclosure may include the controller 800 that estimates the information about the target particles in the sample by using the speckles of the output light OL detected by the sensor portion 300.

The controller 800 may acquire speckle images of the light detected by the sensor portion 300 in a time-serial manner.

For example, the controller 800 may acquire the speckle image of the first input light IL1 or the speckle image of the scattered light SL from the first sensor 310 in a time-serial manner and may acquire the speckle image of the second input light IL2 or the speckle image of the output light OL from the second sensor 320 in a time-serial manner.

The controller 800 acquires the speckle image of the light detected by the sensor portion 300 in the time-serial manner and may estimate/acquire whether the target particles exist in the sample accommodated in the first chamber 110 or information about the target particles.

Referring to FIGS. 1 and 7, the controller 800 may control operations of the light source portion 200. For example, the controller 800 may control the operations of the light source portion 200 so that the light intensity, irradiation direction, wavelength, and frequency of the input light IL irradiated from the light source portion 200 may be adjusted according to a command from the user or the image of the light speckles detected by the sensor portion 300.

Referring to FIGS. 3 and 7, the controller 800 may control the operations of the light distributor 400. For example, the controller 800 may control the operations of the light distributor 400 according to the command from the user or the image of the light speckles detected by the sensor portion 300, so as to adjust the light intensity, irradiation direction, etc. of each of the first input light IL1 and the second input light IL2, and as such, the degrees of light scattering/reflection/interference occurring in the chamber portion 100 may be adjusted.

Referring to FIGS. 4 and 7, the controller 800 may control the operations of the angle adjuster 500. For example, the controller 800 may control the operations of the first angle adjustment unit 510 or the second angle adjustment unit 520 according to the command from the user or the image of the light speckles detected by the sensor portion 300, so as to adjust the light intensity, irradiation direction, etc. of each of the first input light IL1 and the second input light IL2, and as such, the degrees of light scattering/reflection/interference occurring in the chamber portion 100 may be adjusted.

Referring to FIGS. 5 and 7, the controller 800 may control the operations of the polarizer 600. For example, the controller 800 adjusts a position, posture, or polarization axis of the first polarization unit 610 or the second polarization unit 620 according to the command from the user or the image of light speckles detected by the sensor portion 300, so as to adjust a kind of light acquired by the second sensor 320, and as such, the noise of the light speckles detected by the second sensor 320 may be effectively reduced.

Referring to FIGS. 6 and 7, the controller 800 may change the size of the magnetic field applied to the first region by controlling the operations of the magnetic field generator 700. Accordingly, the size of the excited light EL may be amplified through the change in the magnetic field, or speckles of the output light OL due to the excited light EL may be appropriately detected.

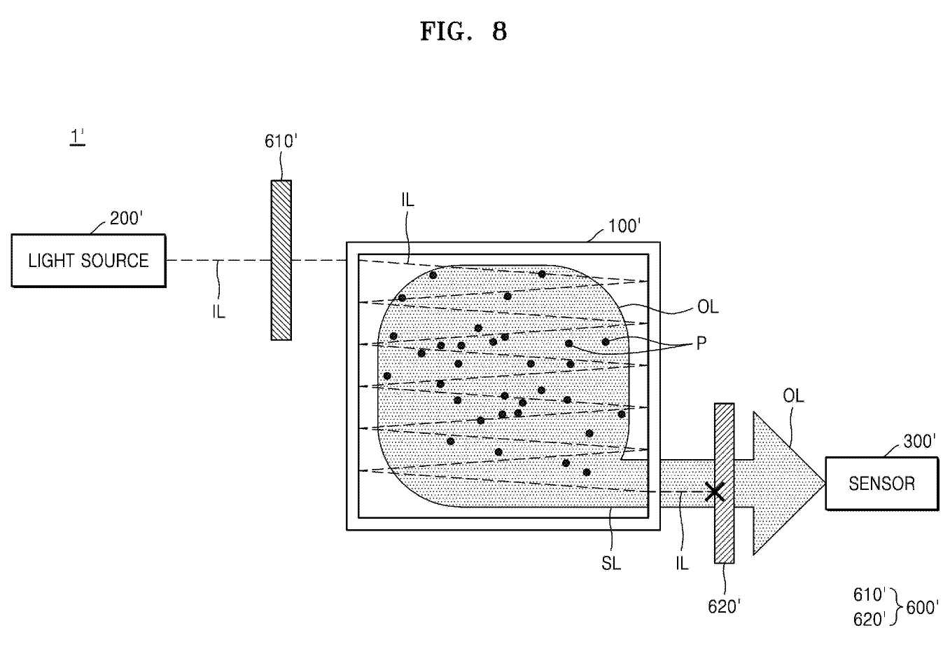

FIG. 8 is a diagram schematically showing an optical measuring apparatus according to an embodiment of the present disclosure.

Referring to FIG. 8, an optical measuring apparatus 1' according to another embodiment of the present disclosure may include a chamber portion 100', a light source portion 200', a sensor portion 300', and a polarizer 600'.

The light source portion 200' and the sensor portion 300' of the optical measuring apparatus 1' according to another embodiment of the present disclosure have the same operating principles and effects as those of the light source portion 200 and the sensor portion 300 of the optical measuring apparatus 1 according to the embodiment of the present disclosure, and thus, redundant descriptions are omitted.

Referring to FIG. 8, the chamber portion 100' according to another embodiment of the present disclosure may provide a space in which the input light IL input from the light source portion 200' may be multi-reflected or multi-scattered through multiple passages.

An entrance through which the input light IL may pass is formed at one side of the chamber portion 100', which faces the light source portion 200', and an outlet for discharging the output light OL or the input light IL to the outside may be formed at one side of the chamber portion 100', which faces the sensor portion 300'.

The target particles may be accommodated in the chamber portion 100', and the input light IL irradiated into the chamber portion 100' may be multi-scattered and multi-reflected while colliding with an inner circumferential surface of the chamber portion 100' or the target particles, and as such, the scattered light SL or the speckles of the scattered light SL may be generated.

The chamber portion 100' may be formed as a housing having hollow inside, and the inner circumferential surface of the chamber portion 100' may be formed as a shape or formed of a material capable of maximizing the multiple reflections or multiple scattererings of the input light IL.

For example, the inner circumferential surface of the chamber portion 100' may be formed as a CSMS (web) structure, chiral sculptured thin film (CSTF) structure, photonic crystal structure, a honeycomb structure, isotropic and anisotropic structures, metamaterial structure, polarization maintaining fiber, etc.

In an alternative embodiment, a scattering layer may be applied onto the inner circumferential surface of the chamber portion 100'. The scattering layer may include a scattering material, for example, the scattering layer may include a hexagonal-boron nitride (h-BN).

In an alternative embodiment, the inner circumferential surface of the chamber portion 100' may have a preset roughness, for example, the inner circumferential surface of the chamber portion 100' may have a regular or irregular concavo-convex structure, thereby implementing a multiple scatterering amplification function.

In an alternative embodiment, a multiple scatterer that increases an optical path length of the input light IL may be arranged in the chamber portion 100'. The multiple scatterer may be arranged on an optical path of the input light IL, and the multiple scatterer may amplify the number of times that the light irradiated from the light source portion 200' to the chamber portion 100' is multi-scattered so that the optical path length of the scattered light SL or the input light IL may increase in the chamber portion 100'.

The polarizer 600' may include a first polarization unit 610' and a second polarization unit 620'. The first polarization unit 610' is arranged between the chamber portion 100' and the light source portion 200' and may be arranged on the optical path of the input light IL, and the second polarization unit 620' may be arranged between the chamber portion 100' and the sensor portion 300' and on the optical path of the scattered light SL.

In an embodiment, the polarization axis of the first polarization unit 610' and the polarization axis of the second polarization unit 620' may be perpendicular to each other.

Some of the input light IL irradiated into the chamber portion 100' may not interfere with the scattered light SL, but may be multi-reflected and multi-scattered while maintaining original properties, and the input light IL having the original properties may be discharged toward the sensor portion 300' through the outlet of the chamber portion 100'.

The sensor portion 300' detects speckles of the scattered light SL that is generated by scattering the input light IL to estimate the information about the target particles, and thus, when the sensor portion 300' detects the input light IL that maintains the original properties along with the speckles of the scattered light SL, it may be difficult to precisely detect the speckles of the scattered light SL.

Unlike this, when some of the input light IL polarized by the first polarization unit 610' and irradiated into the chamber portion 100' generates the scattered light SL due to the interaction with the target particles, the scattered light SL loses its original properties that are polarized earlier.

The second polarization unit 620' is arranged between the chamber portion 100' and the sensor portion 300' and on the optical path of the scattered light SL, and the polarization axis of the second polarization unit 620' may be perpendicular or nearly perpendicular to the polarization axis of the first polarization unit 610'.

In this case, the input light IL that maintains its original properties and is polarized by the first polarization unit 610' and the scattered light SL that loses the polarization property are both discharged toward the sensor portion 300' through the outlet of the chamber portion 100', but the input light IL that is discharged without being scattered is still in the polarized state, and may not pass through the second polarization unit 620' having the polarization axis perpendicular to the polarization axis of the first polarization unit 610' and may not reach the second sensor 320'. Unlike this, the scattered light SL may reach the second sensor 320' after passing through the second polarization unit 620'.

As such, the second polarization unit 620' selectively transmits, toward the sensor portion 300', only the scattered light SL generated through the interaction with the target particles, and accordingly, the noise from the data acquired by the controller may be reduced and the information about the target particles may be precisely detected/estimated.

The present disclosure has been described in detail. However, it should be understood that the detailed description and specific examples, while indicating preferred embodiments of the disclosure, are given by way of illustration only, since various changes and modifications within the spirit and scope of the disclosure will become apparent to one of ordinary skill in the art from this detailed description.

### Industrial Applicability

According to an embodiment of the present disclosure, provided is an optical measuring apparatus. According to an embodiment of the present disclosure, embodiments of the present disclosure may be applied to devices for detecting particles using optical methods in industrial applications, etc.

1. An optical measuring apparatus comprising:
a chamber portion including a first chamber accommodating a sample, and a second chamber providing a space in which light interference with scattered light emitted from the first chamber occurs;
a light source portion irradiating input light toward the chamber portion;
a sensor portion detecting speckles of output light that is output from the chamber portion; and
a controller configured to estimate information about target particles in the sample by using the speckles of the detected output light.

2. The optical measuring apparatus of claim 1, wherein
the chamber portion further includes
a barrier wall portion partitioning inside of the first chamber and inside of the second chamber from each other, and transmitting the scattered light.

3. The optical measuring apparatus of claim 1, wherein
the input light irradiated from the light source portion includes
first input light irradiated into the first chamber and second input light irradiated into the second chamber, the first input light and the target particles colliding with each other in the first chamber to generate the scattered light, and
the sensor portion detects the speckles of the output light that is generated through light interference between the scattered light and the second input light in the second chamber.

4. The optical measuring apparatus of claim 3, further comprising
a light distributor that is arranged between the chamber portion and the light source portion and branches the input light irradiated from the light source portion into the first input light and the second input light,
wherein the first input light and the second input light branched by the light distributor have wavelengths within a same range.

5. The optical measuring apparatus of claim 3, further comprising
an angle adjuster that is arranged between the chamber portion and the light source portion, and is capable of adjusting an incident angle of the first input light or an incident angle of the second input light with respect to the chamber portion.

6. The optical measuring apparatus of claim 3, wherein
the sensor portion comprises:
a first sensor that is arranged adjacent to the first chamber and detects the scattered light; and
a second sensor that is arranged closer to the second chamber than the first sensor and measures the output light, and
a light intensity of the output light acquired by the second sensor is relatively greater than a light intensity of the scattered light acquired by the first sensor.

7. The optical measuring apparatus of claim 3, further comprising
a polarizer that is arranged on an optical path of the second input light and has a polarization axis set in advance.

8. An optical measuring apparatus comprising:
a light source portion generating input light;
a chamber portion providing a space in which the input light input from the light source portion is multi-reflected or multi-scattered through multiple passages;
a sensor portion detecting speckles of scattered light output from the chamber portion;
a first polarization unit that is arranged between the chamber portion and the light source portion and arranged on an optical path of the input light; and
a second polarization unit that is arranged between the chamber portion and the sensor portion, arranged on an optical path of the scattered light, and has a polarization axis crossing a polarization axis of the first polarization unit.

9. The optical measuring apparatus of claim 8, wherein
the polarization axis of the first polarization unit and the polarization axis of the second polarization unit are perpendicular to each other.

10. The optical measuring apparatus of claim 8, further comprising
a driver capable of adjusting the polarization axis of the second polarization unit.
